(19) United States
(12) Patent Application Publication
(10) Pub. No.: US 2019/0324413 A1
(43) Pub. Date: Oct. 24, 2019

(54) PREVENTION OF FAILURES IN THE OPERATION OF A MOTORIZED DOOR

(71) Applicant: SIEMENS MOBILITY GMBH, München (DE)

(72) Inventor: Francesco FERRONI, München (DE)

(73) Assignee: Siemens Mobility GmbH, München (DE)

(21) Appl. No.: 16/310,045

(22) PCT Filed: Jun. 14, 2016
(86) PCT No.: PCT/EP2016/063625

§ 371 Date: Dec. 14, 2018

(51) Int. Cl. G05B 19/042; G06N 20/00; E05F 15/60

(52) U.S. Cl. CPC G05B 19/042; G06N 20/00; E05Y 2900/531; G05B 2219/25255; E05Y 2900/51; E05F 15/60

(57) ABSTRACT

A method for the prevention of failures in the operation of a motorized door. At least one sensor provides time series sensor data of at least one variable of a motorized door. The time series sensor data is used for machine learning in order to monitor, detect and/or predict anomalies in the operation of the motorized door. There is also described a monitoring system for a motorized door that is configured to carry out the method.

The invention refers to a method for the prevention of failures in the operation of a motorized door comprising at least one sensor adapted to provide time series sensor data of at least one variable of the motorized door and to a monitoring system for a motorized door.

Motorized doors come to use in many different vehicles as, for example, in trains. Especially in trains with a high throughput and short station waiting times as, for example, in commuter trains or metro trains, the components of these doors are exposed to a high strain and quickly become subject to wear and tear. This causes these components to be worn-out in shorter cycles, compared to the components of other (motorized) doors, which in general increases the failure rate in the operation of the same. Furthermore, also other so called condition anomalies of motorized doors can interfere with their smooth operation. Therefore, it is necessary to perform a condition monitoring which allows evaluating the operational state of a motorized door and enables a maintenance of the same in due time.

In the state of the art, it is common to perform such a condition monitoring by comparing a motor current of the driving motor of a motorized door to a predefined threshold value. When the amount of the motor current surpasses the threshold value, a diagnostic code is activated. However, this method is not very practicable, not predictive and often the aforementioned threshold value is set too high, so that the motorized door is already broken when the threshold value is reached. Therefore, such methods enable the occurrence of failures in the operation of a motorized door and do not prevent them from damage.

For this reason, it is an object of the invention to provide a method for the efficient prevention of failures in the operation of a motorized door, which allows an efficient monitoring of a motorized door, is predictive and prevents the door from being subject to excessive wear and from breaking.

According to the invention, it is provided a method for the prevention of failures in the operation of a motorized door. The method comprises at least one sensor adapted to provide time series sensor data of at least one variable of a motorized door. Furthermore, the method is characterized in that the time series sensor data is used for machine learning in order to monitor, detect and/or predict anomalies in the operation of the motorized door. Preferably, the at least one sensor is adapted to provide time series sensor data of at least one parameter of the motorized door.

The method according to the invention brings machine learning to motorized doors of trains, allowing an optimized monitoring of the motorized door and a prevention of damages and failures in the operation of the same.

In a preferred embodiment, the machine learning is performed by a neural network. Neural networks in part emulate biological systems, allow efficient learning and can easily be trained. Furthermore, neural networks allow a better monitoring of the condition of a motorized door with every learning cycle.

Preferably, the neural network is a convolutional-recurrent neural network. Convolutional neural networks are well suited for image recognition tasks. Recurrent neural networks are well suited for speech recognition and natural language processing tasks. The combination of these neural networks means a combination of these advantages.

In a preferred embodiment, the at least one variable comprises a motor current of a driving motor of the motorized door and/or an operational state of the motorized door. Furthermore preferred, the at least one variable comprises a value of the motor current of a driving motor of the motorized door and/or a value representing an operational state of the motorized door. Preferably, an operational state of the motorized door is a position of the motorized door or of a door element of the motorized door. In a furthermore preferred embodiment, the operational state of the motorized door is the operational state of at least one door element, especially of at least one moveable door element, particularly preferred of a transversally moveable wing of the motorized door. Preferably the motor current is the electrical current that is used to power a driving motor adapted to open and close the motorized door. In such an embodiment, the time series sensor data referring to the motor current can be combined with time series sensor data referring to the operational state of the motorized door in order to perform a precise monitoring of the motorized door and to allow predictions enabling an improved maintenance of the same.

Preferably, the method comprises the step of performing an unsupervised learning of operational modes of the motorized door using the time series sensor data. Unsupervised learning advantageously allows identifying structures within the time series sensor data.

In a preferred embodiment, a dynamic time-warping algorithm is used within the step of performing an unsupervised learning in order to compare time series sensor data to each other. Preferably, within the step of performing an unsupervised learning in order to compare time series sensor data to each other, different time series sensor data sets are compared to each other. Preferably, the time series sensor data sets are then clustered using a hierarchical algorithm. Preferably, the perfect trace of each normal operation mode is calculated by a mean afterwards. Preferably, the individual time series sensor data is then benchmarked to the perfect traces also using dynamic time-warping. Furthermore preferred, each cluster associated to a normal mode is then fed to a separate one-class novelty-detection support vector machine, wherein every machine reads the sensor sequence and evaluates whether it belongs to its normal operating mode. Preferably, if all machines evaluate the sequence as an anomaly, it is labeled as such.

Moreover preferred, the step of performing an unsupervised learning comprises the steps of extracting different time series sensor data sets referring to normal and/or to abnormal operational modes of the motorized door respectively and generating labels for the extracted different time series sensor data sets respectively. In such an embodiment, a machine learning algorithm used for the method can efficiently learn to differ between a variety of operational modes and to precisely evaluate these operational modes of a motorized door.

Preferably, generated labels denote operational states of the motorized door.

Preferably, the method further comprises the step of performing a supervised learning of operational modes of the motorized door using the time series sensor data. Supervised learning advantageously allows generalizing a solution which enables a machine learning algorithm used within the method to find solutions to similar related problems.

Preferably, the machine learning is performed by a machine learning algorithm. Furthermore preferred, the step of performing a supervised learning comprises the step of using generated labels to train the machine learning algorithm to classify normal and/or abnormal operational modes of the motorized door based on time series sensor data. In such an embodiment, normal and/or abnormal operational modes of the motorized door can be precisely detected and taken into account for a prediction according to a predefined scheme.

Preferably, a normal operational mode of the motorized door is a mode of the motorized door in which it operates in a predetermined manner, e.g. fully opening and/or closing in a manner that consumes a motor current with a value that is in a predefined range.

Preferably, an abnormal operational mode of the motorized door is a mode of the motorized door in which it does not operate in a predetermined manner, e.g. in which it does not fully open and/or close and/or in which it consumes a motor current with a value that is not in a predefined range.

In a preferred embodiment, the step of performing a supervised learning comprises the step of using experimental labels which were generated in experiments to train the machine learning algorithm to classify normal and/or abnormal operational modes of the motorized door based on time series sensor data. In a furthermore preferred embodiment, the step of performing a supervised learning comprises the step of using generated labels and experimental labels which were generated in experiments to train the machine learning algorithm to classify normal and/or abnormal operational modes of the motorized door based on time series sensor data. By the use of experimental labels, the monitoring efficiency and prediction capability of the method is improved.

Preferably, the method further comprises the step of filtering time series sensor data based on the classification. Moreover preferred, the method further comprises the step of filtering time series sensor data based on the classification of the operational mode corresponding to the respective time series sensor data. In such an embodiment, time series sensor data corresponding to operational modes of the motorized door which shall not be taken into account, for example, abnormal operational states of the motorized door due to an interaction with a human being, e.g. a passenger blocking the door, can be excluded from the learning procedure. Expressed in other words, in this step, so called operational anomalies that e.g. occur when a passenger is blocking the motorized door, forcefully re-opens it or leans on the motorized door while it is closing can be excluded from the machine learning procedure by neglecting the time series sensor data which corresponds to these operational anomalies.

Preferably, in the step of filtering, sensor data belonging to predefined normal and/or abnormal operational modes of the motorized door is filtered out. Furthermore preferred, in the step of filtering, sensor data corresponding to predefined normal and/or abnormal operational modes of the motorized door is filtered out. With such an embodiment, it is possible to take into account solely the normal and/or abnormal operational modes that are influenced by, for example, electromechanical components of the motorized door.

Preferably, the method further comprises the step of extracting predefined target time series data sets from filtered time series sensor data. In such an embodiment, only desired normal and/or abnormal operational modes of the motorized door are taken into account for machine learning.

Preferably, a first group of target time series data sets represent the motor current of a driving motor of the motorized door during a free motion of the motorized door respectively, wherein in free motion the motorized door is moving at a constant speed. In such an embodiment, the method among others permits to conclude on the deterioration of the components of the motorized door.

Furthermore preferred, a second group of target time series data sets represent operational states of the motorized door respectively, wherein the second group of target time series data sets is combined with the first group of target time series data sets in order to interpolate the free motion of the motorized door. In this embodiment, the method allows a prediction of the time period after which certain components of the motorized door need to be exchanged or maintained.

Furthermore, a monitoring system for a motorized door is provided. The monitoring system is adapted to perform a method according to the invention. Such a monitoring system allows an efficient and predictive monitoring and avoids the occurrence of failures in the operation of a motorized door, especially in the operation of a motorized door of a train.

The characteristics, features and advantages of this invention and the manner in which they are obtained as described above, will become more apparent and be more clearly understood in connection with the following description of exemplary embodiments, which are explained with reference to the accompanying drawings.

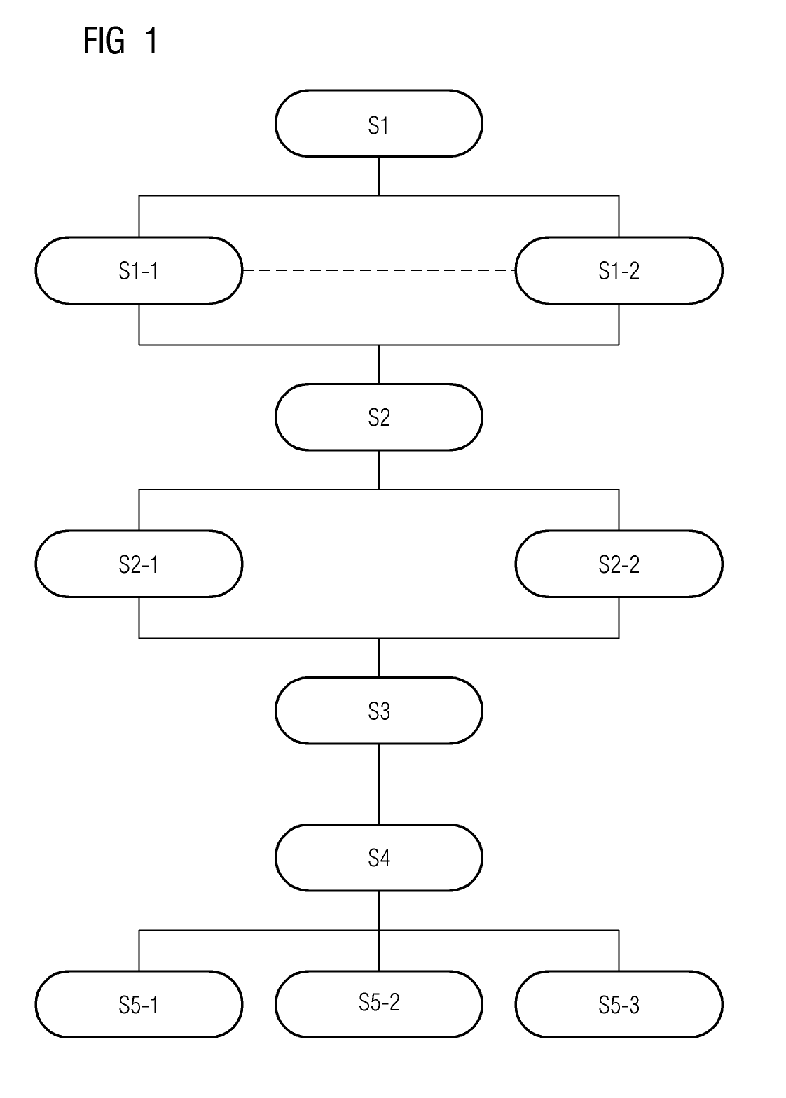

FIG. 1 shows a flow diagram of an embodiment of a method according to the invention, and

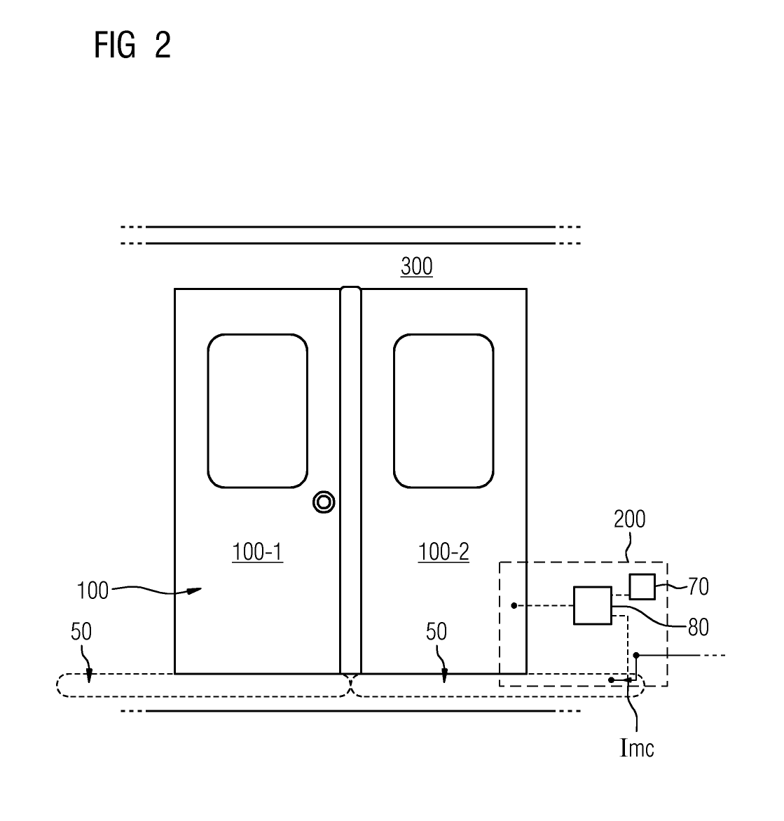

FIG. 2 shows an embodiment of a monitoring system for a motorized door according to the invention.

In FIG. 1, a flow diagram of an embodiment of a method for the prevention of failures in the operation of a motorized door according to the invention is shown. In this embodiment, the method comprises two sensors (not shown) adapted to provide time series sensor data of a motor current for a driving motor of a motorized door and time series sensor data of an operational state of the motorized door. However, also other variables or parameters of a motorized door can be the subject of time series sensor data of a sensor used in a method according to the invention. For example, time series sensor data of diagnostic codes of the motorized door can alternatively or additionally be captured. In this embodiment, the time series sensor data is used for machine learning in order to monitor S5-1, detect S5-2 and predict S5-3 anomalies in the operation of the motorized door. However, other embodiments of methods according to the invention can be carried out in which time series sensor data is used for machine learning solely in order to monitor S5-1 or solely in order to detect or solely in order to predict anomalies in the operation of the motorized door. In this embodiment, the motorized door exemplarily is the motorized door of a train.

Furthermore, in this embodiment the machine learning is exemplarily performed by a convolutional-recurrent neural network. However, also other embodiments of methods according to the invention can be carried out in which other neural networks or even other machine learning algorithms come to use. The method exemplarily comprises the step of performing an unsupervised learning S1 of operational modes of the motorized door using the time series sensor data provided by the sensor. In this embodiment, a normal operational mode can, for example, comprise the information that the motorized door has fully opened or closed correctly and that the motor current of the driving motor of the motorized door had a predefined course or characteristic. An abnormal operational mode can, for example, comprise the information that an anomaly in the opening or closing procedure of the motorized door has been detected and/or the motor current had an undesired value or characteristic during the opening or closing procedure of the motorized door.

In this embodiment, the step of performing an unsupervised learning S1 comprises the steps of extracting S1-1 different time series sensor data sets referring to normal and to abnormal operational modes of the motorized door respectively and generating labels S1-2 for the extracted different time series sensor data sets respectively. Such labels can e.g. be directed to opening states or closure states of the motorized door. In FIG. 1, the dotted line indicates that labels are generated for extracted time series sensor data sets. In other words, the time series sensor data is passed through several steps of feature learning, normal and abnormal operational modes are extracted and labels for such data are automatically generated. This step is necessary for an uncalibrated, untrained system and for data discovery.

In this embodiment, the method further comprises the step of performing a supervised learning S2 of operational modes of the motorized door using the time series sensor data wherein the machine learning is performed via a machine learning algorithm. Furthermore, the step of performing a supervised learning S2 further comprises the step of using generated labels to train the machine learning algorithm S2-1 to classify normal and abnormal operational modes of the motorized door based on time series sensor data. Expressed in other words, labels that have been generated in the step S1-2 described hereinbefore are used to train the machine learning algorithm S2-1 to classify normal and abnormal operational modes of the motorized door based on time series sensor data. This will allow the machine learning algorithm to improve its capability to identify a certain time series sensor data set corresponding to a certain normal and abnormal operational mode of the motorized door. Moreover, in this embodiment, the step of performing a supervised learning S2 further comprises the step of using experimental labels which were generated in experiments to train the machine learning algorithm S2-2 to classify normal and abnormal operational modes of the motorized door based on time series sensor data. Expressed in other words, in this embodiment, the machine learning algorithm is further fed with experimental labels which were the result of experiments to train the classification capabilities of the machine learning algorithm. For example, in a trained state, if the motorized door opens and closes N times correctly, the machine learning algorithm will N times process a label denoting that N open and closure procedures have been performed correctly. Expressed in other words, the labels from the first step S1 of the method and also from experiments are used to train a machine learning algorithm to classify various normal and abnormal operational modes based on raw sensor data.

Moreover, the method further comprises the step of filtering S3 time series sensor data based on the classification. For example, in this embodiment of a method according to the invention, time series sensor data belonging to an abnormal operational state of the motorized door, which is due to a human interaction with the door, is filtered out. In more detail, in this embodiment, time series sensor data that is generated when, for example, a passenger is positioned in the doorframe during a closure of the motorized door will be filtered out. Consequently, in this embodiment, all abnormal modes of operation of the motorized door that are taken into account by the method and utilized for a monitoring or prediction are due to so called condition anomalies as, for example, wear of the door components or a reduced lubrication of a doors screw drive. Expressed in other words, in the third step S3 of the method, based on the classification of the supervised algorithm in the second step S2 of the method, sensor data is filtered accordingly to account only for desired modes of operation.

In this embodiment, the method further comprises the step of extracting predefined target time series data sets S4 from filtered time series sensor data. Exemplarily, in this embodiment, a first group of target time series data sets extracted represent the motor current of the driving motor of the motorized door during a free motion of the motorized door respectively, wherein in free motion the motorized door is moving at a constant speed. Furthermore, a second group of target time series data sets extracted represent operational states of the motorized door, e.g. of the door position and movement, during this free motion of the motorized door respectively. In this embodiment, the second group of target time series data sets is combined with the first group of target time series data sets in order to interpolate the free motion of the motorized door. Therefore, in this embodiment, the method allows a prediction of the time period after which certain components of the motorized door need to be exchanged or other condition anomalies need to be addressed. In more detail, over time the components as, for example, the hinges and the gear of the motorized door or its driving motor are worn out which is realized and processed by the machine learning algorithm on the basis of an increase of the motor current or a reduction in the speed of the motorized door during a free motion within a closure or an opening procedure of the same. However, other condition anomalies that can be spotted, monitored and/or predicted also by other embodiments of methods according to the invention can, for example, be reduced lubrication on the screw drive of the motorized door, excessive friction on a rail due to build up of debris or an incorrect installation of components of the motorized door or the like. Thereby, the machine learning algorithm learns to predict the time in which certain components of the motorized door need to be exchanged or maintained. Expressed in other words, in the fourth step S4 of the method, the filtered time series sensor data of the motor current from the third step S3 is used and particular features are extracted. Specifically, the motor current during a free motion of the motorized door is found to be particularly valuable. This means when the door is moving at a constant speed, after the initial acceleration and before final deceleration. This information can be interpolated when combined with time series sensor data of the position sensor.

In this embodiment, the motor current features as the motor current during free motions are scored to a learned benchmark, monitored and used for a predictive failure algorithm. Therefore, the method in this embodiment serves to monitor S5-1, detect S5-2 and predict S5-3 anomalies in the operation of the motorized door. The monitoring S5-1 can e.g. be used by a train maintenance crew to check the status of the motorized door or during root-cause-of-failure investigations. The scoring is used in conjunction of an anomaly detection system, so in conjunction with an anomaly detection S5-2 to issue warnings or repair orders on motor current data. The predictive failure algorithm is used in conjunction to historical failure data to train an additional machine learning layer to make predictions S5-3 in the future of motorized door failure based on the score and/or other data sources.

Moreover, in this embodiment a dynamic time-warping algorithm is used within the step of performing an unsupervised learning in order to compare time series sensor data to each other. Within the step of performing an unsupervised learning in order to compare time series sensor data to each other, different time series sensor data sets are compared to each other, wherein the time series sensor data sets are then clustered using a hierarchical algorithm. Furthermore, the perfect trace of each normal operation mode is calculated by a mean afterwards and the individual time series sensor data is then benchmarked to the perfect traces also using dynamic time-warping. Finally, each cluster associated to a normal mode is then fed to a separate one-class novelty-detection support vector machine, wherein every machine reads the sensor sequence and evaluates whether it belongs to its normal operating mode. In this embodiment, if all machines evaluate the sequence as an anomaly, it is labeled as such.

In Summary, the invention is the merging of real-time operational information and condition information of the motorized door to monitor the motorized door, thereby improving information quality for monitoring purposes and prediction accuracy if predictions on failure(s) are made.

In this embodiment, from the point of view of a maintenance of the motorized door, only the so called condition anomalies are important and taken into account by the machine learning algorithm of the method. However, monitoring and predictions need to account for and/or filter operational realities.

In FIG. 2, an embodiment of a monitoring system 200 for a motorized door 100 according to the invention is shown. In this embodiment, the motorized door 100 exemplarily is the motorized door 100 of a train 300. The motorized door 100 comprises a first and a second wing 100-1, 100-2 which both can be laterally moved for an opening and a closure of the motorized door 100. The lateral movement of the first and the second wing 100-1, 100-2 is enabled by a driving motor 50 respectively. The monitoring system 200 exemplarily comprises multiple sensors 80, in this embodiment adapted to sense a motor current Imc flowing from a power source (not shown) to the driving motors 50 of the motorized door 100. Furthermore, the multiple sensors 80 are adapted to sense an operational state of the motorized door 100 and to provide time series sensor data of the motor current Imc and of the operational state of the motorized door 100. The monitoring system 200 further comprises a machine leaning unit 70 which in this embodiment is exemplarily connected to the multiple sensors 80. In this embodiment, the monitoring system 200 exemplarily is adapted to perform the method as described with respect to FIG. 1 hereinbefore.

While this invention has been described in connection with what is presently considered to be practical exemplary embodiments, it is to be understood that the invention is not limited to the disclosed embodiments, but, on the contrary, is intended to cover various modifications and equivalent arrangements included within the scope of the appended claims.

1-15. (canceled)

16. A method for preventing failures in an operation of a motorized door, the method comprising:
providing at least one sensor and acquiring with the at least one sensor time series sensor data of at least one variable of the motorized door;
using the time series sensor data for machine learning in order to monitor, detect and/or predict anomalies in the operation of the motorized door.

17. The method according to claim 16, which comprises performing the machine learning by a neural network.

18. The method according to claim 17, wherein the neural network is a convolutional-recurrent neural network.

19. The method according to claim 16, wherein the at least one variable comprises at least one of a motor current of a driving motor of the motorized door and an operational state of the motorized door.

20. The method according to claim 16, which further comprises a step of performing an unsupervised learning of operational modes of the motorized door using the time series sensor data.

21. The method according to claim 20, wherein the step of performing the unsupervised learning includes using a dynamic time-warping algorithm to compare time series sensor data to each other.

22. The method according to claim 20, wherein the step of performing the unsupervised learning comprises the steps of:
extracting different time series sensor data sets referring to normal and/or to abnormal operational modes of the motorized door respectively; and
generating labels for the extracted different time series sensor data sets respectively.

23. The method according to claim 20, which further comprises a step of performing a supervised learning of operational modes of the motorized door using the time series sensor data.

24. The method according to claim 23, wherein the machine learning is performed by a machine learning algorithm and wherein the step of performing the supervised learning comprises the step of:
using generated labels to train the machine learning algorithm to classify normal and/or abnormal operational modes of the motorized door based on the time series sensor data.

25. The method according to claim 24, which further comprises a step of filtering the time series sensor data based on the classification.

26. The method according to claim 23, wherein the step of performing the supervised learning comprises the step of:
using experimental labels which were generated in experiments to train the machine learning algorithm to classify normal and/or abnormal operational modes of the motorized door based on the time series sensor data.

27. The method according to claim 26, which further comprises a step of filtering the time series sensor data based on the classification.

28. The method according to claim 27, wherein in the step of filtering comprises filtering out sensor data belonging to predefined normal and/or abnormal operational modes of the motorized door.

29. The method according to claim 27, which further comprises a step of extracting predefined target time series data sets from filtered time series sensor data.

30. The method according to claim 29, wherein a first group of target time series data sets represent the motor current of a driving motor of the motorized door during a free motion of the motorized door when the motorized door is moving at a constant speed.

31. A monitoring system for a motorized door, configured to carry out the method according to claim 16.
